(19) United States
(12) Patent Application Publication
(10) Pub. No.: US 2006/0236573 A1
(43) Pub. Date: Oct. 26, 2006

(54) Display apparatus for changing images

(76) Inventor: Jozsef Bognar, Budapest (HU)

Correspondence Address: LADAS & PARRY, 26 WEST 61ST STREET, NEW YORK, NY, 10023, US

(21) Appl. No.: 10/540,046

(22) PCT Filed: Dec. 22, 2003
(86) PCT No.: PCT/HU03/00107

§ 371 Date: Dec. 15, 2005

(30) Foreign Application Priority Data
Dec. 23, 2002 (HU) P0204489

(51) Int. Cl. G09F 7/00; G09F 11/00

(52) U.S. Cl. 40/488; 40/491

(57) ABSTRACT

The invention relates to a display apparatus for changing images. The apparatus comprises a cassette unit adapted for replacement as a single unit. The cassette unit comprises multiple sheet-formed image carriers (21,22,23,24). The image carriers (21,22,23,24) comprises image parts constituting at least two different images. The image carriers (21,22,23,24) are subdivided into panels adapted for sliding between each other. The cassette unit further comprises a back plate (42) covering a side of one of the image carriers (21,22,23,24). The display apparatus further comprises moving means (30) for moving the different image carriers (21,22,23,24) relative to each other, and a frame (28) for supporting the cassette with the image carriers (21,22,23,24) and the moving means. According to the invention, one of the image carriers (21,22) is fixedly attached to the back plate (42) along its edges. The back plate (42) is movable relative to the frame (28), and the moving means (30) is adapted for moving the back plate (42).

The invention pertains to a display apparatus for changing images that is capable of presenting multiple images (changing usually two or three different images) by the application of multiple image carriers. These image carriers comprise image parts constituting at least two different images. The image carriers are subdivided into panels, and the panels are adapted for sliding between each other. The image carriers are displaced relative to each other by a suitable moving means, and they are often covered by a transparent cover sheet.

Indoor advertising, more particularly, POP (Point of Purchase) and POS (Point of Sale) advertising is becoming more and more important all over the globe. The rapid increase of indoor advertising calls for more intensive use of available advertising surfaces. One way of exploiting the full potential of a given advertising surface is presenting alternating or cyclically changing images. This not only intensifies the use of the advertising surface, but grabs the attention of the observers more effectively than static advertisements, simply because of the moving, changing images. A prior art solution for changing images is the so called “prismatic” advertising board that uses multiple prism-shaped elements, triangular in cross-section. Each image is composed of sections located on one of the three faces of the prism-shaped elements, and the images are changed by the synchronized rotation of the image-bearing elements. Prismatic boards look unwieldy in many indoor environments and cannot be visually appealing due to their excessive weight and dimensions. Also, they are not capable of changing images on both of their sides. A serious disadvantage of small-size advertising devices of the above kind is that images have to be glued together and cut into sections on-site, which is a very labor-intensive task. It is mainly due to these disadvantages that prismatic boards could not have become widespread in indoor applications.

Other prior art display apparatus for changing images achieve the presentation of alternating images by means of image carriers subdivided into panels that are adapted for sliding between each other. Such apparatus are disclosed for instance by U.S. Pat. No. 5,974,709, U.S. Pat. No. 4,783,923 and U.S. Pat. No. 3,430,771. In these patents the image carrier is made of a relatively strong and rigid material, and the image carriers are moved relative to one another by a complex mechanism. That makes the display apparatus relatively bulky and heavy. Because the rigid image carriers are in themselves costly, the replacement of the images to be presented is also expensive. Normally, images printed on paper are best suited to be viewed by a human eye. Using paper for display purposes is cheap, and printed images on paper has outstanding visual quality, and may be observed from a wide angle. Therefore, it is desirable to use paper for advertising posters.

Another example of an image carrier comprising panels adapted for sliding between each other can be known from U.S. Pat. No. 3,659,367, where the image carriers are made of paper. The apparatus disclosed in U.S. Pat. No. 3,659,367 has a pair of image carriers which constitutes the first image is covered by a transparent cover sheet, with said pair of image carriers being attached to said transparent cover sheet. Panels of the image carrier bearing the second image are attached to a back plate individually, and the back plate is moved relative to the fixed image carrier. This image changing apparatus has relatively simple structure and is made of cheap materials but does not provide for the simple and quick replacement of image carriers (in the described embodiments the image carriers are not replaceable at all).

U.S. Pat. No. 5,974,709 discloses a solution where the image carrier means are joined in a cassette-like unit that can be placed into a frame. A mechanism suited to provide for the relative displacement of the image carriers of the cassette unit is disposed inside the frame, so it becomes possible to replace only the cassette-like unit when new images are to be presented. Nevertheless, with this apparatus the need for the application of image carriers made of relatively strong material remains, which makes individual replacement cassettes expensive and reduces the possibility of using such cassette units in large numbers.

The object of the present invention is therefore to provide a display apparatus for changing images that is ideal for indoor use, is lightweight, has small footprint, can be operated with image carriers made of paper, provides good image quality, optionally capable of presenting images on both of its sides, can be produced cheaply, and provides for the quick and easy replacement of images. It is particularly the object of the invention that conventional paper posters, advertisements should be applicable in the apparatus.

Accordingly, the invention relates to a display apparatus for changing images comprising a cassette unit adapted for replacement as a single unit. The cassette unit comprises multiple sheet-formed image carriers, the image carrier comprising image parts constituting at least two different images, and the image carriers being subdivided into panels adapted for sliding between each other. The cassette unit further comprising a back plate covering a side of one of the image carriers. The display apparatus further comprises moving means for moving the different image carriers relative to each other, and a frame for supporting the cassette with the image carriers and the moving means. According to the invention, one of the image carriers is fixedly attached to the back plate along its edges. The back plate is movable relative to the frame, and the moving means is adapted for moving the back plate.

In the display apparatus of the invention images can be reliably changed, even when image carriers of relatively low mechanical strength are applied, such as advertising posters made of paper. The back plate, attached to the edge of the image carriers made of paper, can transfer force along the whole paper sheet in order to move the paper sheet, while it does not prevent the panels from sliding between each other at the central region of the sheets. If paper image carriers of conventional thickness are used, overlaps of image carriers at locations where panels slide between each other become practically invisible for the viewer of the presented image.

The moving of the back plate offers several advantages. The moving means may be fixed to the back plate in a practically arbitrary location, because it remains invisible (covered by the image carrier sheets). It does not disturb the advertisement on the front side. Because of this visual cover, there are a number of possible technical solutions for attaching the moving means to the back plate.

Since the attachment point is on the back plate, the moving means itself may be located in various places. It may be behind the back plate, in the direct vicinity of the attachment point. Alternatively, the moving means may be separated from the frame, above or below the frame.

In case of a wall-mounted display, it is sufficient to use a thin and barely visible nylon cord, driven by a small motor and an eccentric disk, for raising and lowering the back plate. The motor itself may be located in a small and inconspicuous box sufficiently far away from the display, so that an observer will not immediately notice the connection between the box and the display. The display itself may remain very flat. The motor can be so small that it may be mounted in a mains socket or a mains switch housing, providing an even better disguise for the motor. In this manner the display will appear as if it were completely devoid of any moving mechanism, and the moving action will be even more puzzling for the observer. Such motors with an eccentric mechanism are readily available in commerce, for a very low price, i.e. the complete moving mechanism may be extremely simple and cheap.

Therefore, comparing the display of the invention with a stationary poster, all that is needed for the display are two printed posters, and the simple and cheap motor. Accordingly, the completed display may be very low-cost.

Since it is the back plate that is being moved, the front cover sheet may remain stationary relative to the support frame and/or to a decorative frame. On the front of the display, a decorative frame may be painted on the front cover sheet. The stationary front cover sheet will not be scratched, and will preserve its aesthetic appearance. Children or other persons will not be able to stop the movement of the display by touching the front cover sheet.

Exploiting the fact that the moving means is attached to the back plate, a simple and efficient connecting element between the moving means and the back plate may provided, for example by two anti-parallel magnets. Preferably, the connecting element between the back plate and the moving means provides a detachable joint between the back plate and the appropriate element of the moving means. The connecting element may automatically establish the connection when the cassette unit with the image carriers is inserted into the frame, and the connection is also automatically and simply released when the cassette unit is removed from the frame.

Such a connecting element is also capable of exactly positioning the image carriers (which is important to ensure the smooth functioning of the display). Even if the image carriers are stuck, or halted by an external force, so that the image carriers can not move, the connection between the back plate and the moving means is released. After the obstacle is removed, the connection may be restored automatically. The image carriers will not be torn, and the motor will also not burn down either. This magnetic connection element functions in all positions, i. when the movement of the back plate is vertical or horizontal, even when the plane of the display is also horizontal.

In another aspect of the invention, there is disclosed a display apparatus for changing images. The display apparatus comprises a cassette unit adapted for replacement as a single unit, and comprising multiple sheet-formed image carriers. The image carrier comprise image parts constituting at least two different images, and the image carriers are subdivided into panels adapted for sliding between each other. The cassette unit further comprises a back plate and a front cover sheet covering the front and back side of the image carriers. The display unit also comprises moving means for moving the different image carriers relative to each other, and a frame for supporting the cassette with the image carriers and the moving means. In an embodiment of the invention, one of the image carriers is fixedly attached to the back plate along its edges. The cassette unit is formed exclusively of flexible sheets, substantially without any empty volume or empty space between the flexible sheets within the cassette unit. The sheets covering the image carriers fit closely to the image carriers.

With a cassette unit having the above structure, it is possible to change images with image carriers made of a relatively thin paper, and simultaneously in a relatively large size, such as those normally used for advertising posters. In this manner the cassette unit is very flat, and an A0 sized cassette unit may be treated in a similar manner as a large flexible plastic sheet. It may be rolled up, if necessary, and a large number may be stacked within a modest packing height.

The invention will now be explained in detail referring to the attached drawings where

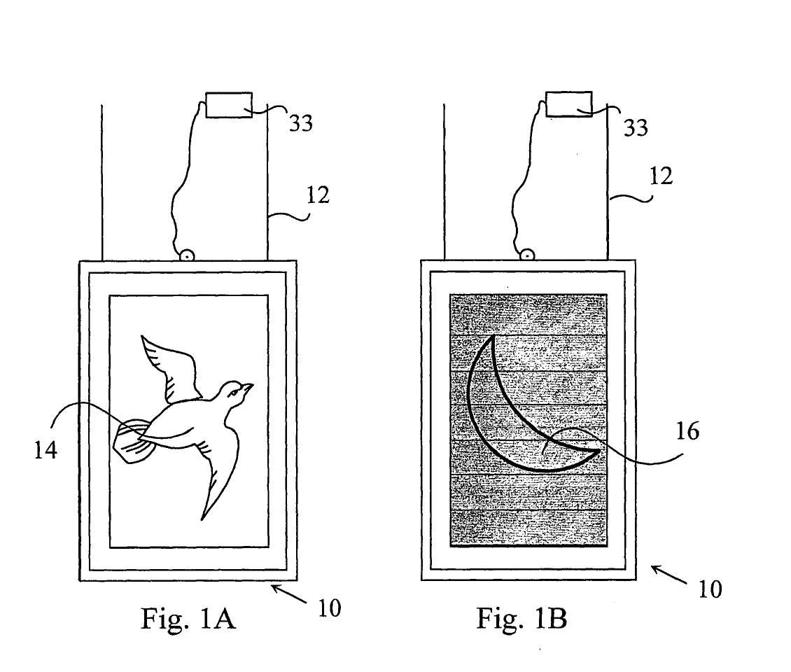

FIG. 1A. shows the front view of the display apparatus of the invention presenting a first image,

FIG. 1B. shows the front view of the display apparatus presenting a second image,

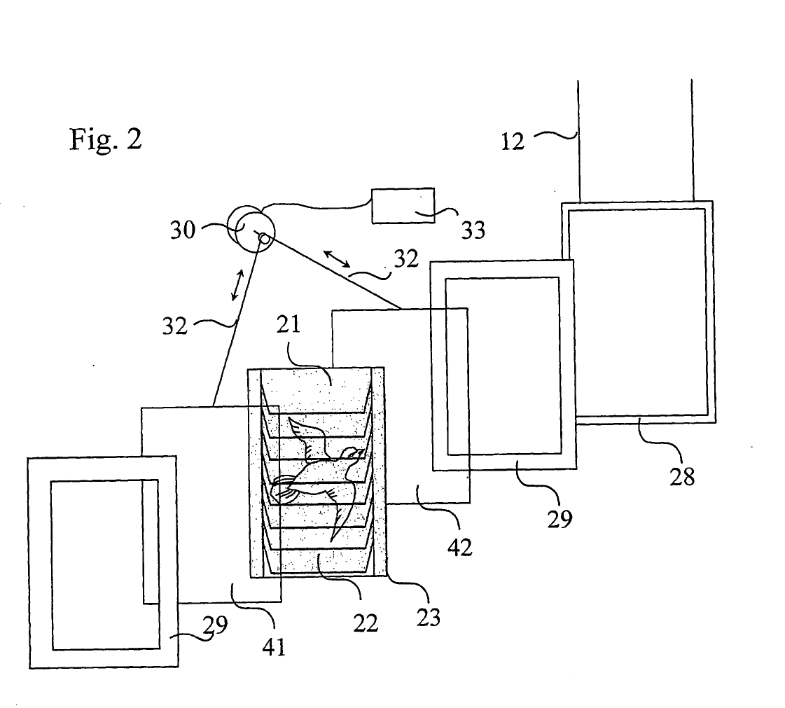

FIG. 2 is an exploded view illustrating the structure of the display apparatus shown in FIG. 1A,

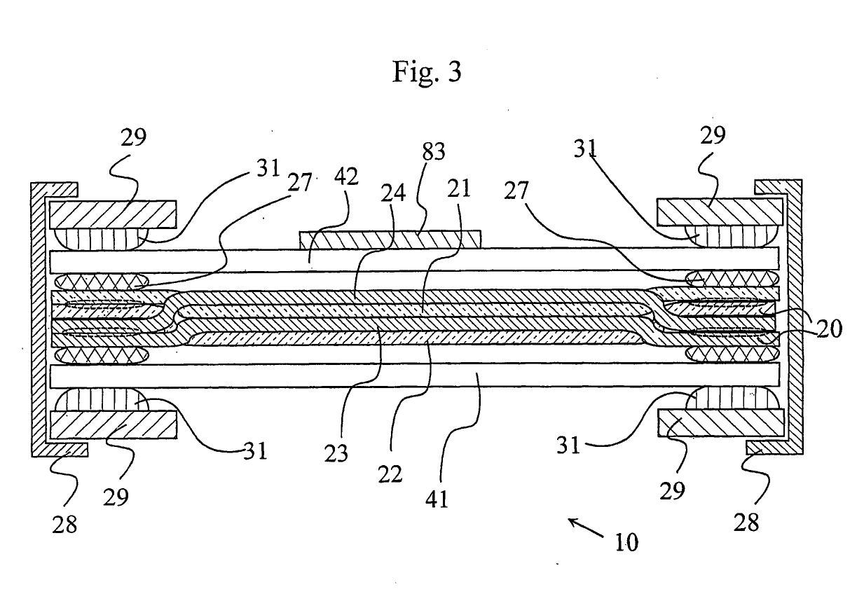

FIG. 3 is a highly magnified cross section view of the display apparatus of FIG. 1A taken along a horizontal plane relative to FIG. 1A and shown on a distorted thickness scale, illustrating the structure of the apparatus,

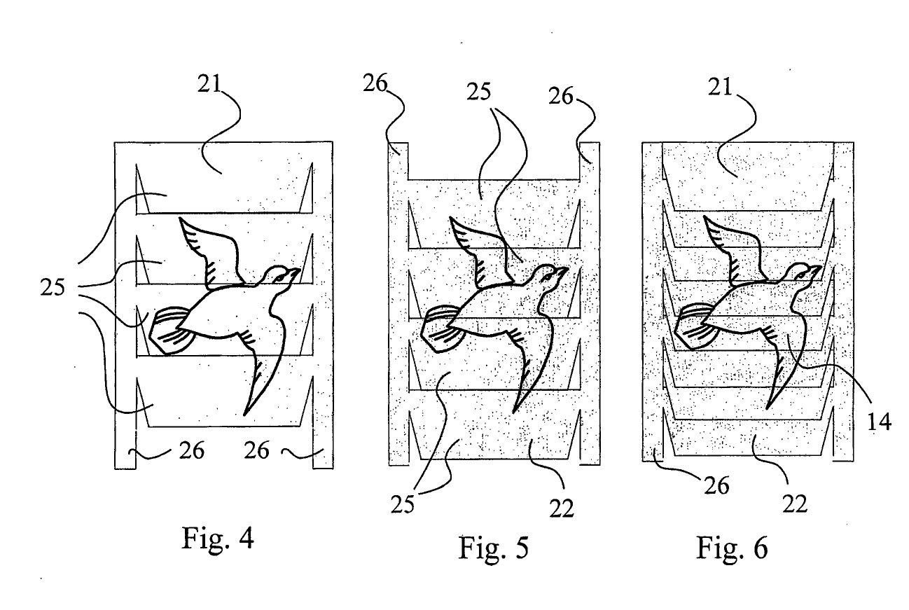

FIG. 4 shows the configuration of an image carrier applied in the display apparatus of FIG. 1A bearing a first image,

FIG. 5. illustrates the configuration of a further image carrier bearing the same image as the image carrier shown in FIG. 4,

FIG. 6 illustrates the manner of joining the image carriers shown in FIGS. 4-5,

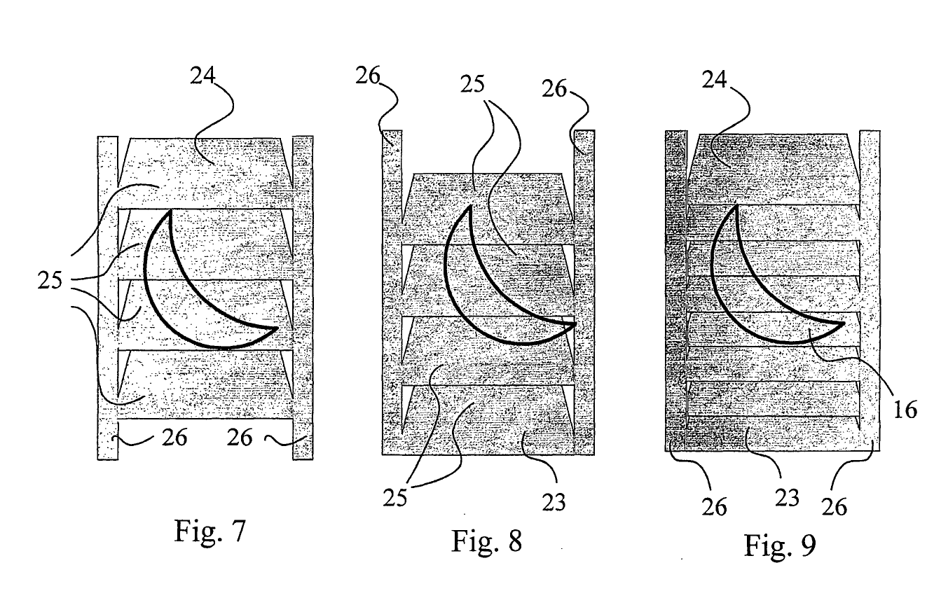

FIG. 7 illustrates the configuration of an image carrier applied in the display apparatus of FIG. 1A bearing a second image,

FIG. 8 shows the configuration of a further image carrier bearing the same image as the image carrier shown in FIG. 7,

FIG. 9 illustrates the manner of joining the image carriers shown in FIGS. 7-8,

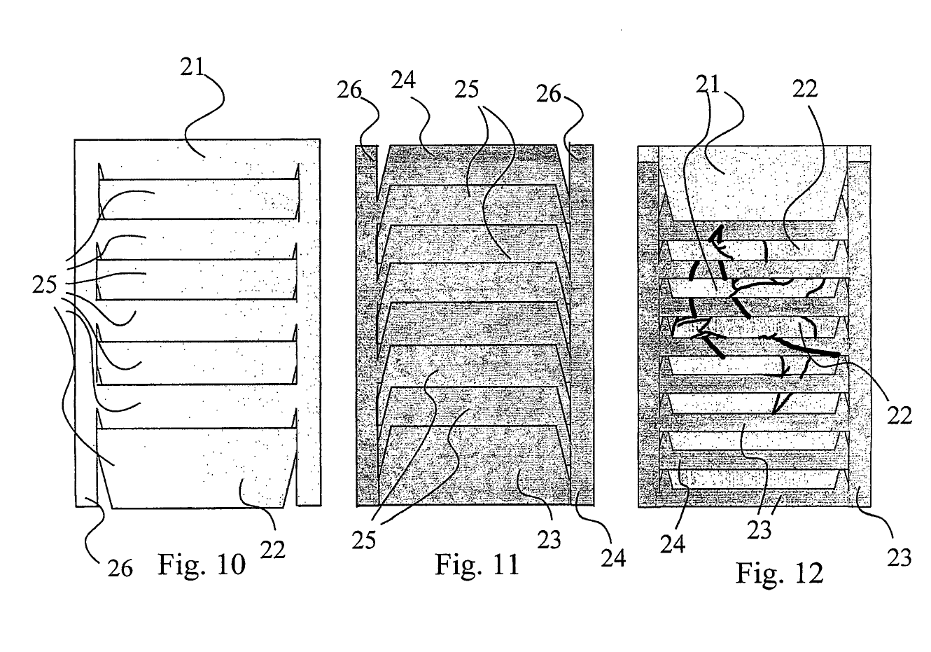

FIG. 10 is the rear view of the pair of image carriers of FIG. 6,

FIG. 11 is the rear view of the pair of image carriers of FIG. 9,

FIG. 12 illustrates the manner of joining the pairs of image carriers shown in FIGS. 6 and 9 as seen from the image-bearing surface thereof,

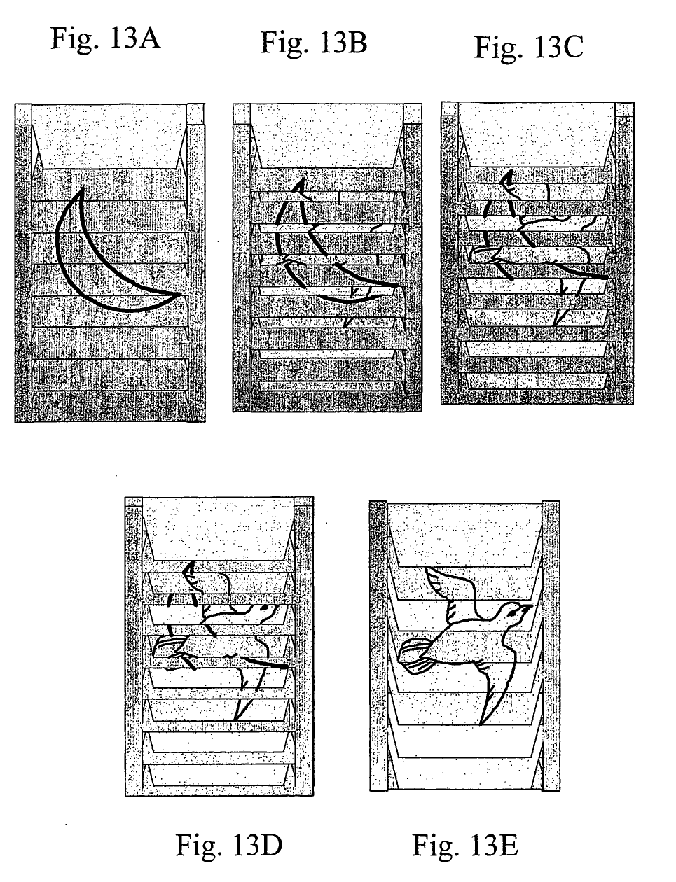

FIGS. 13A-13E show the image carrier set of FIG. 12 in subsequent phases of the image changing process,

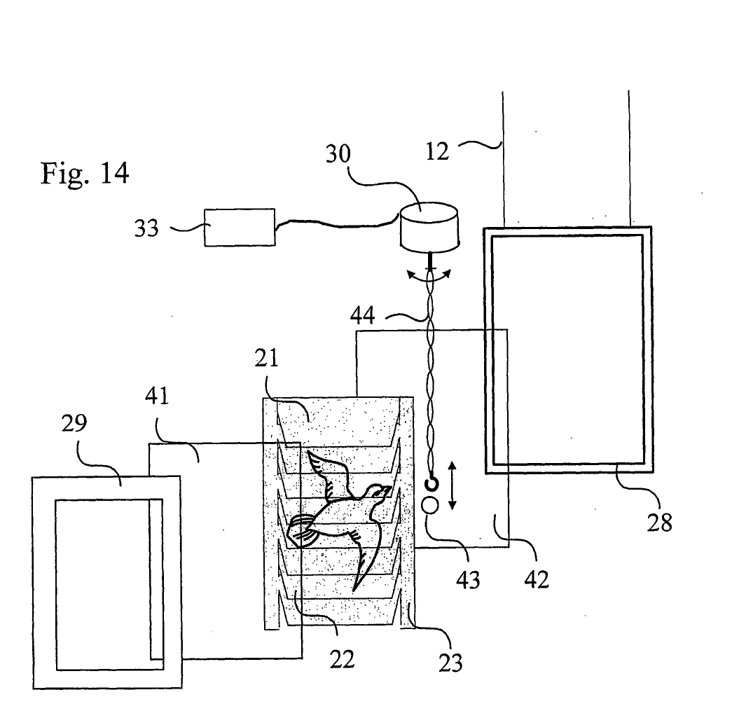

FIG. 14 is an exploded view of a further embodiment of the display apparatus,

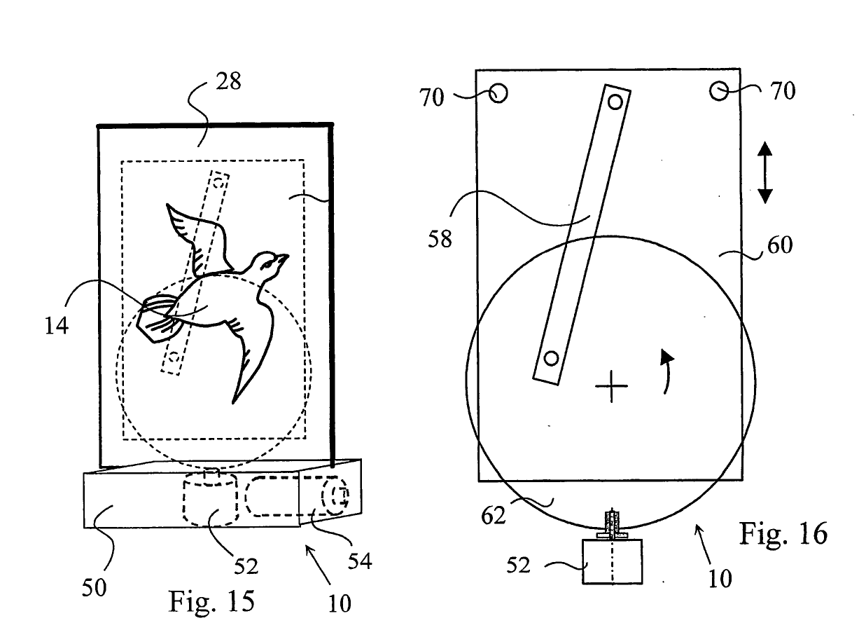

FIG. 15 is a schematic frontal view of a further embodiment of the display apparatus,

FIG. 16 shows the front view of the drive mechanism of the display apparatus of FIG. 15,

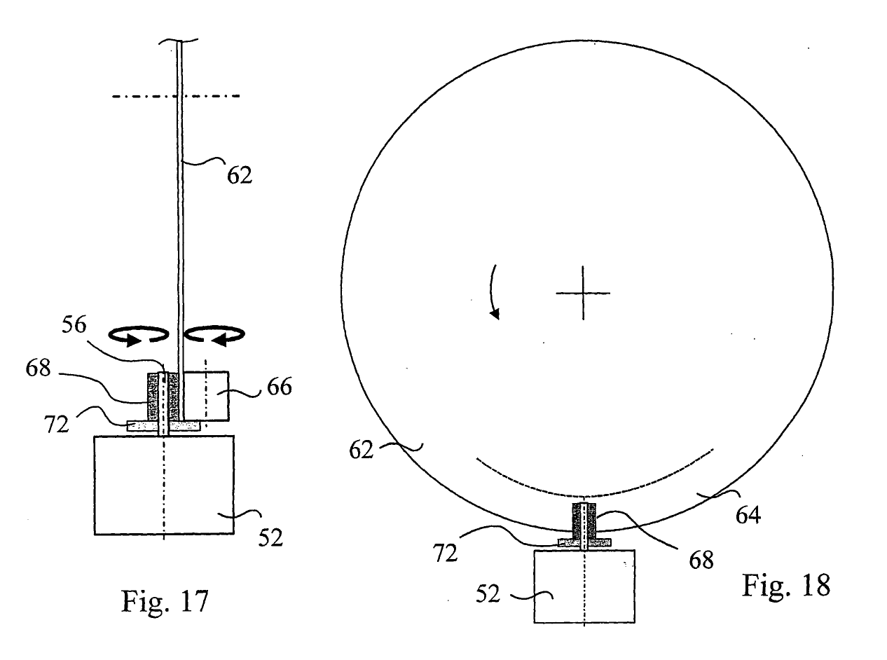

FIG. 17 shows a side elevation view of the drive mechanism illustrated in FIG. 16,

FIG. 18 is another view of a detail of the drive mechanism shown in FIG. 16,

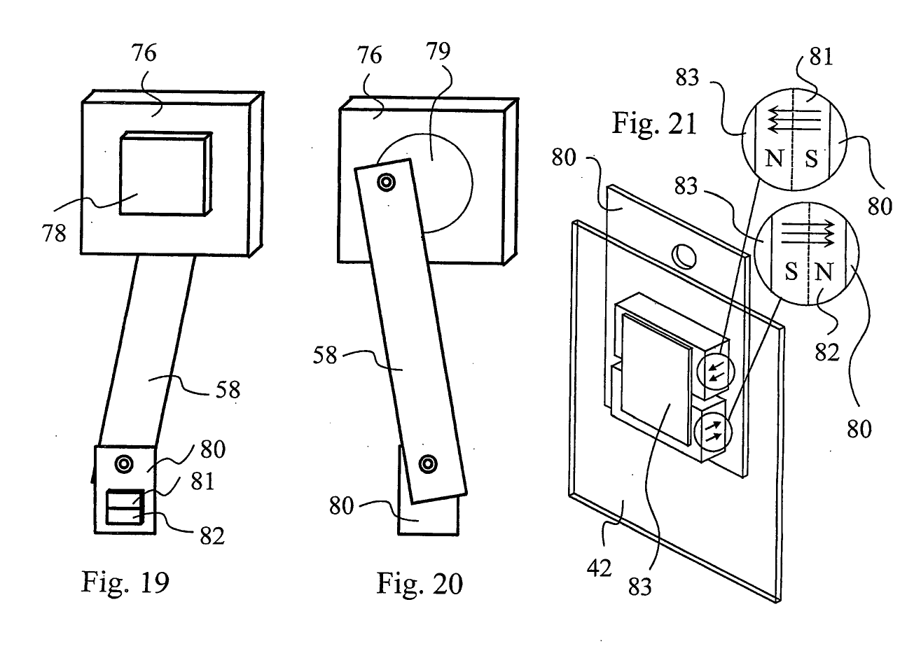

FIG. 19 is a front view of an embodiment of the moving means, with a connecting element,

FIG. 20 is a rear view of the moving means shown in FIG. 19,

FIG. 21 is an enlarged view of the connecting element shown in FIG. 19,

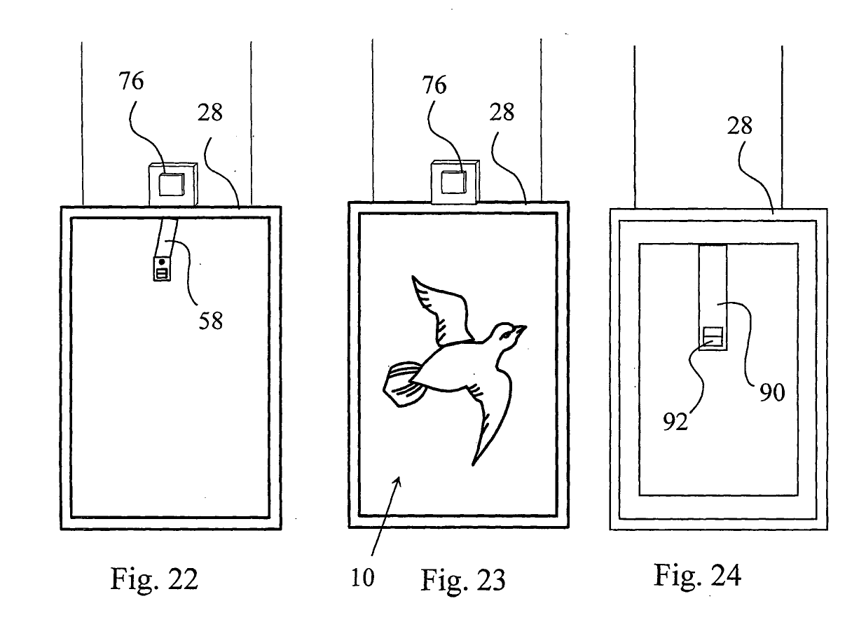

FIG. 22 is a schematic figure of the support frame and the moving means shown in FIG. 19,

FIG. 23 illustrates the display apparatus with the frame and moving means shown in FIG. 19, with the inserted cassette unit, and finally

FIG. 24 is a schematic frontal view of a further embodiment of frame and moving means of the display apparatus.

Referring now to FIGS. 1A, 1B, 2, and 3, a display apparatus 10 for changing images is shown, suspended similarly to picture by two suitable hanging means, for example two nylon cords 12. In the operating state shown in FIG. 1A, the display apparatus 10 presents a first image 14 showing a dove, whereas in the operating state shown in FIG. 1B the display apparatus 10 presents the second image 16, which in this case is a crescent-like shape.

The principle of changing images applied in the display apparatus 10 is realized by multiple image carriers comprising image parts constituting at least two different images. The image carriers are subdivided into panels, which latter are adapted for sliding between each other. Because the panels of the image carrier slide between each other, the image presented by the display apparatus 10 gives the best visual impression if the image carriers are substantially two-dimensional sheets or plates, with a negligible thickness relative to the size of the image.

In the embodiment herein described the image parts of the first and second images 14, 16 are disposed on image carriers 21, 22, 23, 24. The image carriers 21, 22, 23, 24 are preferably made of paper. As it is best seen in FIGS. 4-9, the image carriers are subdivided into slat-like panels 25 that in the assembled state of the image carriers 21, 22, 23, 24 can slide between each other.

In the embodiment shown in the drawings, one image is presented by a pair of image carriers: the first image 14 is presented by image carriers 21 and 22, and the second image 16 is presented by image carriers 23 and 24.

However, an embodiment can also be conceived where one image is presented by a single image carrier, that is, the alternation of two images can be achieved with only two image carriers. Such image carrier arrangements are also known in the art. In this case the image quality can be negatively affected by the fact that during the image-changing process a narrow strip of the panels of the image carrier associated to the actually hidden image remains visible. This effect can be eliminated by using transparent guiding plates that do not bear any part of the image. However, the application of such transparent guiding plates is complicated, and renders the assembly of the cassette of the image carriers more difficult.

The display apparatus 10 comprises a moving means, driven in the described embodiment by a small-size electric motor 30, for moving the image carriers 21, 22, 23, 24 relative to one another.

In their assembled state, the image carriers 21, 22, 23, 24 are covered with a transparent cover sheet 41 at the front and with back plate 42 at the back. The back plate 42 may be either transparent or opaque, depending on whether the back side of the image carriers 21, 22, 23, 24 need to be seen or not. The cover sheet 41 and back plate 42 not only protect the image carriers, but, as it is described below, perform a motive function as well.

Two pairs of image carriers, consisting of image carriers 21, 22 and 23, 24, respectively, are fixedly attached to the adjoining cover sheet. As it is best seen in FIG. 3, the image carrier pair consisting of image carriers 21, 22 is attached to the back plate 42, whereas the pair consisting of image carriers 23, 24 is attached to the front cover sheet 41. The panels of the image carrier pairs are glued to each other along the spines 26, that is, the image carrier 21 is glued to the image carrier 22, and similarly, the image carrier 23 is glued to the image carrier 24 (see the adhesion points 20 in FIG. 3). The adjacent spines 26 of the image carriers 22 and 24 are, however, not glued together, so they can slide relative to each other. The image carrier 21 is attached along its borders to the back plate 42, and the image carrier 23 is attached to the cover sheet 41 in a similar manner. As it can be best seen in FIG. 3, the image carriers 21 and 23 are attached to the back plate 42 and to the cover sheet 41, respectively, with double-sided adhesive tape, for example with the tape 27 shown in FIG. 3.

The image carriers 21 to 24, the electric motor 30 (constituting the moving means), and the transparent cover sheet 41 and back plate 42 are enclosed by a frame 28, which provides sufficient mechanical support for the mentioned elements. In certain cases mechanical support can be achieved even if the frame 28 does not fully enclose the cassette constituted by the image carriers and the back plate. In the present embodiment the frame 28 comprises a further decorative frame 29 that is implemented as a separate piece, but the decorative frame 29 and the frame 28 can also be formed as a single-piece element.

The decorative frame 29 hides the spine 26 of the image carriers 21, 22, 23, 24, and also the transitional region between the spines 26 and the panels 25, so that only the panels 25 will be visible. In this manner the decorative frame 29 and provides aesthetic visual appearance.

The transparent cover sheet 41 and back plate 42 can be moved with respect to the frame 28, more particularly they can slide up and down inside the frame 28. In the embodiment of FIG. 2, the drive mechanism attached to the electric motor 30 is connected to the cover sheet 41 and the back plate 42 and not directly to the image carriers 21, 22, 23, 24. That way the moving means is adapted for moving the transparent cover sheet 41 and back plate 42. In the embodiment now described the cover sheet 41 and the back plate 42 are supported by a cord 32 wound onto the axle of the electric motor 30 (or onto another appropriate rotating means driven by the electric motor 30 through a suitable driving gear).

In case the image carriers are integrated into a cassette unit it may be expedient that the electric motor 30 moves only one of the two transparent plates, for instance the back plate 42. In this case it suffices that the moving means of the frame is attached to the back plate, which may render the practical implementation of the entire display apparatus much simpler. For example, the back plate may be equipped with a ferromagnetic sheet 83, which, as explained in detail with reference to FIG. 21, may serve as a connecting element together with magnets moved by the motor 30. In certain cases, such as the embodiment of FIG. 2, it may also prove useful if the frame 28 comprises a second sheet, and the moving means moves this second sheet and the transparent cover sheet simultaneously in opposite directions. In this latter situation, however, the most expedient solution is that said second sheet should be the transparent cover sheet 41 itself. For instance, this way it is not necessary to fix the end of the cord 32 (that is wound onto the axle of the electric motor) to the axle but it is enough to wind a few revolutions around the axle and attach the other end of the cord to the other moved element (plate or sheet). An advantage of this arrangement is that in case the moving elements get stuck, the cord may slip on the axle and so potential damage to the motor or the image carriers can be averted. In such an embodiment the display apparatus can be designed to be extremely thin.

The ends of the cord 32 are attached to the moved cover sheet 41 and back plate 42 in an easily detachable way. This ensures that images can be replaced quickly and simply. When replacing the images the assembled cassette-like unit consisting of the cover sheet 41, the back plate 42, and the image carriers 21, 22, 23, 24 attached thereto with adhesive tape 27 can be replaced as a single unit on the advertising site. The interlacing of panels 25 of the image carriers 21, 22, 23, 24 can be performed in advance, using an appropriate specialized tool, and thus the interlacing of the panels need not be done on-site.

Because the moved cover sheet 41 and back plate 42 are arranged in a vertical plane and both are attached to the cord 32, the cover sheet 41 and the back plate 42 are alternately lowered and raised by the cord 32 (the lowering or downward motion is achieved with the help of gravity). The desired direction of rotation of the electric motor 30 is set by the controller 33.

The frame 28, more particularly the decorative frame 29 encloses the borders of the image carriers 21, 22, 23, 24, and of the cover sheet 41 and back plate 42, with a friction reducing insert 31 being disposed between the borders of the cover sheets and the decorative frame 29. Thus the cover sheet 41 and the back plate 42 can be made of a relatively thin and lightweight material, e.g. of plastic sheet with a thickness of a few tenths of millimeters, and a very low-power electric motor 30 can be used. Thereby the thickness, weight, and production costs of the display apparatus 10 will be favorably low.

The basic principle for changing images utilized by the apparatus of the invention is known per se. The principle is described in more detail with reference to FIGS. 4-13. In this method the image is subdivided into bands or strips. This is realized by the panels 25 of the image carriers 21, 22, 23, 24. Here, the following problems may arise:

The relative positions of strips belonging to the same image must be fixed with some structural element. This structural element tends to complicate the changeover process of the strips of images to be changed, because it may obstruct the movement of the strips. However, it is important that the panels 25 do not become entangled with one another.

In case the images are cut into separated strips or bands that make up the changeable image construction—i.e. when the (paper) image carriers are cut into strips—, the exact assembly of the image from the strips requires either a costly apparatus or a labor-intensive method.

Thus the image carriers are not cut into separate pieces, but the image carriers are provided with cuts between the strips formed by the panels 25.

Individual strips are held together by a spine 26 along the borders of the panels 25. The strips are prevented from getting entangled and stuck during the image changing process by a suitable guiding piece. According to the embodiment described here, the strips have an increased surface area, and the strips themselves constitute the guiding pieces (see FIG. 4-13). In these latter embodiments of the display apparatus the total surface of the image-forming strips (which are preferably made of paper) is greater than the total surface of the images appearing during the image changing process, because the strips overlap. This is expediently achieved by utilizing more than one copy of at least one image (disposed on paper carriers) in the display apparatus. Two, three, or even more copies can be used, the number being limited in practice by the waists between the spine 26 and the panels 25. These waists that can not be too narrow, otherwise they will tear too easily.

As it has been pointed out, the above mentioned guiding piece can be a separate element, preferably a plate comprising panels arranged similarly to the arrangement of the image carriers and made of a transparent material. The panels of this element can slide between the panels of the image carriers in such a way that the guiding portions of the transparent element reaching beyond the panels of the image carriers are invisible in the presented image (because they are transparent).

The display apparatus 10 is assembled by placing the image carriers with the suitable cut-outs, e.g. image carriers 21, 22 of FIG. 4, 5 over each other, and sliding the panels 25 between each other in a way illustrated in FIG. 6. Now the respective left-hand spines 26 of the two image carriers are glued together, which is followed by gluing together the respective spines 26 of the image carriers on the right side. This way a poster is obtained where each panel 25 is twice as wide as its visible width. Thus the panels 25 need not be entirely drawn apart to make the first image 14 fully disappear and make the second image 16 appear in its entirety. Here the panels 25 have increased width and play the role of guiding pieces (because the panels 25 overlap each other).

For better understanding, the rear view of the combined image carriers of FIG. 6 and FIG. 9 is shown in FIGS. 10 and 11, respectively.

FIGS. 7-9 are analogous to FIGS. 4-6 as far as the second image 16 is concerned. The assembly steps described above are performed with image carriers 24, 25, and then the two pairs of image carriers made up of image carriers 21, 22 and 23, 24 as seen in FIGS. 6 and 9 are interlaced.

FIG. 12 illustrates the finished state of the display apparatus for changing images, with the dove and crescent shapes of FIGS. 6 and 9 having been placed over each other and the panels 25 of the image carriers 21, 22 and 23, 24 interlaced. It must be noted that the back side of the image carriers 21, 22 and 23, 24 may also carry an image. If e.g. the image of a boy is drawn on the side shown in FIG. 10, and the image of e.g. a girl is drawn on the side shown in FIG. 11, then the display apparatus of FIG. 12 simultaneously changes the images of a dove and a crescent on one side and the images of a boy and a girl on its other side.

FIGS. 13A-E shows the operation of the image carrier assembly of FIG. 12, as one pair of image carriers (consisting of image carriers 21, 22) is displaced relative to the other pair of image carriers (constituted by image carriers 23, 24). As the image carrier pair 23,24 slowly moves upward relative to the image carrier pair 21,22, the second image 16 gradually disappears while the first image 14 is gradually appears.

FIG. 14 shows a further embodiment of the inventive display apparatus. The display apparatus of FIG. 14 is a wall-mounted design, where the presented image can only be viewed on the front side of the apparatus. Here only the image pair attached to the back plate 42 is moved relative to the frame 28, by moving the back plate 42 located in the rear. The moving cord is in this case a stranded cord 44 that is rotated by an electric motor 30. The stranded cord 44 changes its length under the effect of twisting. The end of the stranded cord 44 is attached to the back plate 42 in an easily detachable way (e.g. with a lockable hook that can engage a ring 43 or other suitable structure attached to back plate 42). When rotated into a first direction, the stranded cord 44 contracts, just to regain its original length when it is subsequently rotated into the opposite direction. As the cord 44 extends, the back plate 42 moves downward under the effect of gravity.

In this case the front cover sheet 41 does not move, so a separate decorative frame 29 is not strictly needed: the necessary masking can be achieved by painting a colored strip or band onto the cover sheet 41. Thus the frame 28 does not necessarily include a front cover sheet or a decorative frame. However, in the preferred embodiment there is a flexible front cover sheet 41 covering the image carriers, and which provides a lateral reinforcement to the image carrier pair 23,24. When the image cassette is removed from the display apparatus, the frame 28 is emptied entirely. It suffices to attach front surface of the image cassette to one side of the frame (preferably to the upper or bottom side thereof). When the image is vertical, it is often not even necessary to attach the image cassette to the frame, because its weight will keep it in place.

If the display apparatus is operated with battery, it can be expedient to make the moved back plate 42 as lightweight as possible, in order to save energy. However, preferably it should still be heavy enough to move downwards under its own weight.

FIG. 15 shows a further embodiment of the inventive display apparatus, which, similarly to the embodiments illustrated above, can be produced at an extremely low cost. Low production cost is due to the fact that practically no control electronics is needed for controlling the rpm or the direction of rotation of the electric motor (even a 1,5 V-supply is sufficient, which would cause problems with electronic control circuits), there is no need for a mains power supply, cheap (e.g. DC-) motors can be used (the continuous unidirectional operation spares the commutator), and the drive mechanism can also be produced cheaply.

The apparatus of FIG. 15 can be placed on a desk, giving the impression of a photo frame holder. A small-sized DC motor 52 and a battery 54 is disposed in the base 50 of the display apparatus. The rotation of the axle of the motor 52 is transformed into straight-line alternating motion by a simple mechanism illustrated in FIGS. 16 to 18.

In this embodiment the moving means providing for the upward and downward motion of the image carriers comprises a disk 62 that can be rotated in a plane parallel with the plane of the image carriers, a mechanism transforming the rotation of the disk 62 into straight-line motion, and a motor 52 that has an axle 56 parallel with the plane of the disk, with the axle 56 being in frictional contact with the edge portion of the disk.

The mechanism comprises a magnetic roller 66. This magnetic roller 66 is set parallel with the axle 56 of the motor 52, and is in contact with the other side of the disk 62. Because the magnetic roller 66 attracts the steel axle 56 of the motor 52, the magnetic roller 66 presses the edge portion 64 of the disk 62 to the axle 56 of the motor. This magnetic attraction presses the magnetic roller 66 to the rubber cylinder 68 disposed on the axle 56 of the motor 52 and to the flat disk 62 located between the two rotating or rolling elements with a given constant force. The friction drive just described resembles tape drive mechanisms applied in tape recorders, but due to the magnetic cylinder it is simpler, takes up less space, and is cheaper than tape recorder mechanisms. The magnetic roller 66 is prevented from sliding off by a washer 72 disposed on the axle 56 of the motor 52, and it is also held in place laterally by a surrounding small cavity or pocket (not shown) in the base 50 or in the back support plate.

The flat disk 62 is rotated by the friction drive, with the disk 62 causing the up-and-down motion of a moving plate 60 via a flat driving rod 58 that acts as a cam gear. Concealed moving elements that are in principle invisible during the operation of the apparatus are indicated in FIG. 15 with dashed lines. The display apparatus for changing images shown in FIG. 15 comprises the parts in the following order (from back to front): at the far rear is located the rectangular back support plate (not shown in the figure) of the photo holder. The back support plate is fixedly attached to the base 50. In front of the back support plate the flat disk 62 is located, connected to the back support plate e.g. with a tubular rivet acting as axis of rotation. The flat driving rod 58 is located in front of the flat disk 62. The driving rod 58 is rotatably connected at the bottom end thereof to the flat disk 62 with e.g. another tubular rivet. In front of the flat driving rod 58 there is located the rectangular moving plate 60 that is rotatably connected to the upper end of the driving rod 58 with a tubular rivet acting as axis of rotation. Other components of the image cassette (described above and not shown separately in FIGS. 15-18), that is, the back plate 42 and the image carriers adapted for sliding between each other, are disposed in front of the moving plate 60. If necessary, the back plate 42 can be of substantially the same size as the moving plate 60. The mechanical connection between the moving plate 60 and the back plate 42 can be achieved in many ways. In the embodiment herein described a button-shaped magnet 70 is glued on the moving plate 60 at each of the two upper corners thereof. Similarly, a button-shaped iron piece (not shown) is fastened on the back plate 42 at each of the two upper corners thereof, exactly opposite to the location of the button magnets 70. When the button magnets 70, disposed on the moving plate 60 are attracted to the iron pieces of the back plate 42, the back plate 42 of the image cassette is moved by the moving plate 60 making use of the attractive magnetic force.

The drive mechanism shown in FIGS. 15-18 may be further modified. In this modified embodiment, the disk 62 is made of a magnetic material, such as iron. The magnetic roller 66 may be omitted, as well as the rubber roller 68. Instead, a similarly sized magnetic cylinder (not shown) is attached to the axle 56 of the motor 52, and thus rotated by the motor 52. The magnetic cylinder attracts the iron disk 62, and thereby drives the disk 62. This structure allows the use of a slightly thinner frame than the previous one. This is particularly important with wall-mounted displays.

The button magnets 70 and the thin plates attached to the back plate 42, as explained with reference to FIGS. 15-16, may suffice with relatively small-sized displays, but may not be applicable for larger, wall-mounted displays. Firstly, it is desirable to make wall-mounted displays as thin as possible, and therefore only a very flat magnet may be used. When the magnet plates are attached to the plates on the back plate, often the attracting force will not be sufficient, and the magnets and the plate do not cover each other exactly, but they tend to be displaced relative to each other, in an asymmetric fashion, and this relative displacement is quite random. Therefore, exact positioning of the image carriers relative to each other may be difficult. It is also impractical to attach a magnet to the image carriers (i.e. to the back plate 42), because the magnets will stick to each other, when several cassette units are stacked on each other, e.g. during transport. During their subsequent separation, the attracting magnets thus may cause some inconvenience.

Therefore, another suitable moving means with a connecting element between the moving means and the back plate 42 is proposed. An embodiment of the moving means with the proposed connecting element is shown in FIGS. 19-21. The motor 30 is covered by a decorative box 76, which latter may imitate a housing for a fake or real switch 78. The motor drives a driving rod 58 through an eccentric disk 79.

The moving means is also equipped with an iron plate 80 (e.g. attached to the driving rod 58), and a magnet pair of two magnets 81, 82 are glued to the iron plate 80, with the shown anti-parallel polarizations (the letters N, S indicate North and South). Another ferromagnetic plate, for example a thin iron sheet 83 is attached to the back plate 42 (back plate 42 is not to scale in FIG. 21). The iron plate 80 and the iron sheet 83 close the magnetic circuit generated by the magnets 81, 82. When inserting the cassette unit into the frame 28, the iron sheet 83 will be attracted very strongly to the magnets 81, 82 when the iron sheet 83 is moved close to the magnets 81,82, and the iron sheet 83 clamps onto the magnets 82, 82 in an exact position, almost completely symmetrically. In this manner, a sufficiently well-defined positioning between the iron sheet 83 and the moving means is achieved; hence the moving means will be also properly positioned relative to the image carriers.

FIGS. 22 and 23 illustrate the moving means disguised in a box 76 formed as the housing of a mains switch 78. (the mains cable is not shown). FIG. 22 shows the frame 28 of the display apparatus 10 before the insertion of the cassette unit. The frame 28 has an upper slot, so that the cassette unit with the image carriers may be loaded from the top (a so-called topline frame). FIG. 23 shows the display apparatus 10 with the inserted cassette unit.

The display according to the invention may be produced in a very flat embodiment by using so-called artificial muscles. Such devices are known in literature, for example from the publication “ELECTROSTRICTIVE POLYMER ARTIFICIAL MUSCLE ACTUATORS” by Roy Kombluh et al, and published on the website of SRI International, 333 Ravenswood Avenue, Menlo Park, Calif. 94025. (http://www.erg.sri.com/publications/7247-pa-98-032.pdf)

These imitate the operation of a natural muscle. The artificial muscles are mostly strip-formed, and they are able to change their length under the effect of electric current. In this manner, they may be used readily in the moving means for moving the image carriers. For example, FIG. 24 illustrates a frame 28 with an artificial muscle actuator 90 and an attached magnetic connecting element 92. This works in the same manner as the frame 28 shown in FIG. 22, with the only difference that the raising and lowering of the back plate 42 (not shown in FIG. 24) is effected with the artificial muscle actuator 90.

The display apparatus of the invention is suitable as advertising means both for indoor and outdoor use. In case of outdoor use, the image carriers may be reinforced in a known manner against wear caused by rain, humidity, UV-radiation, excessive temperatures and the like.

The invention is not limited to the shown and disclosed embodiments, but other elements, improvements and variations are also within the scope of the invention. For example, it is clear for those skilled in the art that functions of the moving means shown in the figures may be realized by various drive mechanisms, instead of the exemplary mechanisms shown. Also, the disclosed image carriers may be realized in a number of different ways.

1. Display apparatus for changing images, comprising
a. a cassette unit adapted for replacement as a single unit, the cassette unit comprising multiple sheet-formed image carriers, the image carrier comprising image parts constituting at least two different images, and the image carriers being subdivided into panels adapted for sliding between each other, the cassette unit further comprising a back plate covering a side of one of the image carriers,
b. moving means for moving the different image carriers relative to each other, and
c. a frame for supporting the cassette with the image carriers and the moving means, characterized in that
d. one of the image carriers is fixedly attached to the back plate along its edges,
e. the back plate is movable relative to the frame, and
f. the moving means is adapted for moving the back plate.

2. The display apparatus of claim 1, characterized in that the image carriers are substantially two-dimensional plates, with a negligible thickness relative to the size of the image.

3. The display apparatus of claim 2, characterized by that the image carriers are made of paper.

4. The display apparatus according to claim 1, characterized by that an image is displayed by a pair of image carriers.

5. The display apparatus according to claim 1, characterized by that an image is displayed by a single image carrier.

6. The display apparatus according to claim 1, characterized by that there is an image on both sides of the image carrier

7. The display apparatus according to claim 1, characterized by that the frame comprises a second cover sheet, and the moving means is adapted for moving the second cover sheet and the back plate simultaneously, in opposite directions.

8. The display apparatus according to claim 7, characterized by that the second cover sheet is made of a transparent material.

9. The display apparatus according to claim 1, characterized by that the moving means comprises an electric motor with an axle, and a cord wound onto the axle, the moved cover sheet being attached to the cord.

10. The display apparatus according to claim 9, characterized by that the cover sheet is disposed vertically, and the cord lowers or raises the cover sheet.

11. The display apparatus according to claim 1, characterized by that the frame encloses the edges of at least one of the image carriers and the back plate and/or the cover sheet, and the apparatus comprises a friction reducing insert between the edges and the frame.

12. The display apparatus according to claim 1, characterized by that the back plate is made of a transparent material.

13. The display apparatus according to claim 7, characterized by that the image carrier is attached to the cover sheet and/or to the back plate with a double-sided adhesive tape.

14. The display apparatus according to claim 1, characterized by that the moving means comprises a disk adapted for rotation in a plane parallel to the plane of the image carriers, means for transforming the rotating movement of the disk into a straight movement, and a motor having an axle parallel with the plane of the disk, the axle being in a frictional contact with the edge portion of the disk.

15. The display apparatus according to claim 14, comprising a magnetic cylinder being parallel with the axle of the motor, the magnetic cylinder contacting the other side of the disk and pressing the edge portion of the disk to the axle of the motor.

16. The display apparatus according to claim 1, characterized by that the moving means comprises a motor and a cord attached to an axle of the motor, the cord changing its length under the effect of twisting.

17. The display apparatus according to claim 14, characterized by that the moving means comprises a disk having a magnetic material, and a magnetic cylinder attached to the axle of the motor and the magnetic cylinder being in a frictional contact with the edge portion of the disk.

18. The display apparatus according to claim 1, characterized by that the back plate is movable under the force of gravity.

19. The display apparatus according to claim 1, characterized by a magnetic connection between the moving means and the back plate of the cassette unit.

20. The display apparatus according to claim 19, characterized by that the magnetic connection between the back plate of the cassette unit and the moving means is established by a pair of anti-parallel magnets, and two ferromagnetic plates serving as means for closing a magnetic circle of the magnetic lines generated by the magnets.

21. The display apparatus according to claim 1, characterized by that the moving means comprises an artificial muscle.

22. The display apparatus according to claim 1, characterized by comprising a detachable connection between the moving means and the back plate.

23. The display apparatus according to claim 22, characterized by that the detachable connection automatically engages and disengages when the casette unit is inserted into the frame or removed from the frame, respectively.

24. Display apparatus for changing images, comprising
a. a cassette unit adapted for replacement as a single unit, the cassette unit comprising multiple sheet-formed image carriers, the image carrier comprising image parts constituting at least two different images, and the image carriers being subdivided into panels adapted for sliding between each other, the cassette unit further comprising a back plate and a front cover sheet covering the front and back side of the image carriers,
b. moving means for moving the different image carriers relative to each other, and
c. a frame for supporting the cassette with the image carriers and the moving means, characterized in that
d. one of the image carriers is fixedly attached to the back plate along its edges,
e. the cassette unit being formed exclusively of flexible sheets substantially without any empty volume within the cassette unit, and
f. the sheets covering the image carriers fits closely to the image carriers.
